(19) United States
(12) Patent Application Publication
(10) Pub. No.: US 2006/0259885 A1
(43) Pub. Date: Nov. 16, 2006

(54) System and method for analyzing a circuit

(76) Inventors: Michael P. Mortensen, Ft. Collins, CO (US); Robert Y. Seward, Ft. Collins, CO (US)

Correspondence Address: HEWLETT-PACKARD COMPANY;Intellectual Property Administration, P.O. BOX 272400, Fort Collins, CO, 80527-2400, US

(21) Appl. No.: 11/374,283

(22) Filed: Aug. 9, 2004

(51) Int. Cl. G06F 17/50

(52) U.S. Cl. 716/7; 716/2

(57) ABSTRACT

A system and method for analyzing a circuit. In one embodiment, a tool generates path information based upon a netlist that describes the circuit. A synthesizer generates a nodal data structure responsive to the path information. A parser is operable to parse a nodal query to provide a tree structure such that each leaf of the tree structure comprises a segmented expression of the nodal query. A resolver accesses the nodal data structure and tree structure in order to generate a solution set that satisfies at least one of the segmented expressions.

### BACKGROUND

Circuit delay computation and path delay validation represent significant and computationally complex problems in the timing analysis of digital circuits. As a result, recent years have seen the development of an ever increasing number of timing analysis techniques for combinational and sequential circuits. By way of example, dynamic techniques provide results having a high level of accuracy at the expense of high run time by explicitly simulating the circuit under a typical input stream (e.g., switching activity of the input signals, temporal correlations, etc.). On the other hand, static techniques offer sufficiently accurate results with low computational overhead by relying on probabilistic information about the input stream. Additionally, various hybrid timing analysis approaches have been developed that attempt to optimize the efficiency offered by static analysis techniques with the accuracy provided by dynamic analysis techniques.

Regardless of the existing timing analysis technique selected, path-based nodal analysis is critical to circuit delay computation and path delay validation. Path-based nodal analysis traces electrical routes through a series of nodes and reports the traced paths in order from worst to best, with some number of the slow paths being below a target performance and classified as failing paths. Since a single node may be in multiple paths, a single node may be responsible for multiple path failures. Accordingly, the ability to query all paths to determine the effect of a node on multiple paths is a valuable tool for circuit designers. Despite the capabilities of the existing timing analysis techniques, further improvements are warranted in the detection of failing paths as will be described below.

### SUMMARY

A system and method are disclosed that provide for analyzing a circuit. In one embodiment, a tool generates path information based upon a netlist that describes the circuit. A synthesizer generates a nodal data structure responsive to the path information. A parser is operable to parse a nodal query to provide a tree structure such that each leaf of the tree structure comprises a segmented expression of the nodal query. A resolver accesses the nodal data structure and tree structure in order to generate a solution set that satisfies at least one of the segmented expressions.

### BRIEF DESCRIPTION OF THE DRAWINGS

FIG. 1 depicts a block diagram of an embodiment of a system for analyzing a circuit;

FIG. 2 depicts a schematic diagram of one embodiment of an illustrative circuit that is analyzed by the system of FIG. 1;

FIG. 3 depicts one embodiment of a data structure element that is generated based on an illustrative nodal query during the analysis of the circuit of FIG. 2;

FIG. 4 depicts one embodiment of a tree structure that is generated based upon an illustrative nodal query during the analysis of the circuit of FIG. 2; and

FIG. 5 depicts a flow chart of one embodiment of a method for analyzing a circuit.

### DETAILED DESCRIPTION OF THE DRAWINGS

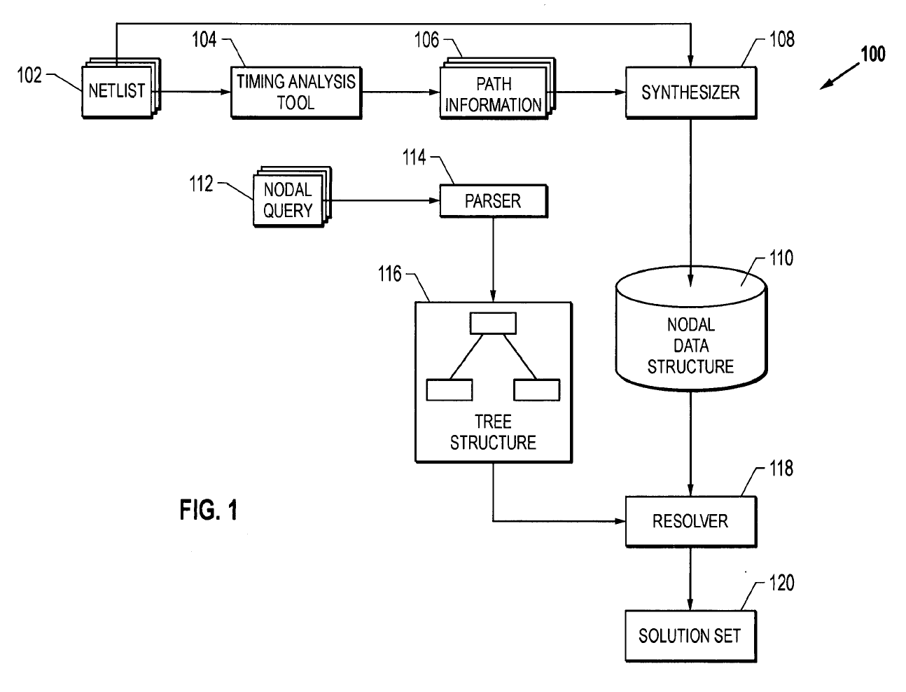

In the drawings, like or similar elements are designated with identical reference numerals throughout the several views thereof, and the various elements depicted are not necessarily drawn to scale. Referring now to FIG. 1, therein is depicted an embodiment of a system 100 for analyzing a circuit under design. In one embodiment, the system 100 may be utilized in association with a timing analysis operation to determine which node or nodes are responsible for a set of failing paths. It should be understood that the system 100 may be utilized during other stages of circuit design and development as well. A netlist 102, which describes the circuit in terms of component entity definitions and interconnectivity, is provided to a timing analysis tool 104 which may utilize any of the aforementioned dynamic, static, or hybrid timing analysis techniques. In one embodiment, the timing analysis tool 104 comprises an electrical robustness checker. The timing analysis tool 104 generates path information 106 by tracing paths through various series of electrical nodes in the circuit such that each path contains nodes between an input point and a subsequent output point.

Upon receiving the path information 106 and the netlist 102, a synthesizer 108 generates a nodal data structure 110 comprising path-node relationships. It should be appreciated that in an alternate embodiment, however, the data structure 110 may be generated based only upon the path information 106. As will be explained in further detail hereinbelow, data structure 110 defines each node in terms of positional path data in order to complement the path information 106 which defines each path in terms of nodes. In particular, data structure 110 includes a collection of a series of tuples that define each node in terms of a path object and position object. It will be seen, therefore, that the data arrangement of the data structure 110 is particularly amenable to supporting a mechanism for identifying all paths associated with a particular node of interest using efficient search criteria.

A nodal query 112 is generated by a circuit designer or expert system, for example, using low-level logical operators, high-level logical operators, and set-level logical operators in order to define expressions that will assist the circuit designer in determining which node or nodes are responsible for failing paths. The low-level logical operators aid in defining expression segments by designating operations to be performed on one or more nodes. The high-level logical operators facilitate creation of more complex nodal queries using Boolean-type search operators, such as NOT, AND, and OR, between the segmented expressions. In terms of a hierarchical arrangement, the high-level logical operators combine segmented expressions together to form leaf nodes and other intermediary levels in a tree structure corresponding to a particular nodal query. Similarly, set-level logical operators provide for mapping of set operations to the logical operators defined between leaves, eventually leading to a tree structure's root node. The low-level logical operators may include the following:

TABLE 1
Low-level Logical Operators

| OPERATOR | USE | MEANING |
|---|---|---|
| => | node 1 => node 2 | True if node 1 and node |
| | | 2 exist in the path and |
| | | node 2 immediately |
| | | follows node 1. |
| =>> | node 1 =>> node 2 | True if node 1 and node |
| | | 2 exist in the path and |
| | | node 2 is positioned |
| | | anywhere after node 1. |
| !> | node 1 !> node 2 | True if node 1 exists in |
| | | the path and node 2 does |
| | | not immediately follow |
| | | node 1. |
| !>> | node 1 !>> node 2 | True if node 1 exists in |
| | | the path and node 2 is |
| | | not anywhere in the path |
| | | after node 1. |
| = = | node 1 == n | True if node 1 is the nth |
| | | node in the path. |

The searching ability and power of the low-level logical operators should be apparent from Table 1. In particular, the operators are capable of expressing the position of a node with respect to another node's position in order to enable search expressions that are more robust than simple string text searches or Boolean-type expressions. As used herein, a node in a nodal expression can either be a name (e.g., shouldnotfail) or a regular expression (e.g., should*), which matches any node beginning with “should”, such as shouldfail, shouldnotfail, etc. Additionally, the low-level operators may be chained together, as in the following expression:
node 1=>>node 2=>node 3!>node 4

This expression evaluates true if the path contains node 1, node 2, and node 3; node 2 follows node 1 anywhere in the path; node 3 follows node 2; and node 4 does not immediately follow node 3. Expression segments may be grouped together using the high-level logical operators as described in the following table:

TABLE 2
High-level Logical Operators

| OPERATOR | USE | Meaning |
|---|---|---|
| ( ) | (expr) | True if the nodal |
| | | expression is true. |
| ! | !expr | True if the nodal |
| | | expression is false. |
| && | expr 1 && expr 2 | True if the nodal |
| | | expressions expr 1 and |
| | | expr 2 are both true. |
| \|\| | expr 1 \|\| expr 2 | True if either nodal |
| | | expression expr 1 or expr |
| | | 2 is true. |

In one implementation, the order of precedence for these high-level logical operators is from top to bottom, i.e., parentheses have the highest precedence and the OR operator has the lowest precedence. However, it is not necessary that separate Boolean searches and set operations be performed with respect to a particular nodal query. Rather, the Boolean operators may be implemented using the set operations, for instance. The various segmented expressions of a nodal query may be combined using set-level logical operators from the following table:

TABLE 3
Set-level Logical Operators

| OPERATOR | USE | SET OPERATION |
|---|---|---|
| && | leaf 1 && leaf 2 | Intersection of leaf 1 |
| | | paths and leaf 2 paths. |
| &&! | leaf 1 &&! leaf 2 | Set difference: leaf 1 |
| | | paths − leaf 2 paths. |
| \|\| | leaf 1 \|\| leaf 2 | Union of leaf 1 paths and |
| | | leaf 2 paths. |
| \|\|! | leaf 1 \|\|! leaf 2 | Union of leaf 1 paths and |
| | | all paths not in leaf 2. |

A parser 114 converts the nodal query 112 into a tree structure 116 having leaves that comprise segmented expressions of the nodal query 112. The parser 114 may be a bottom up, e.g., shift-reduce, parser or a top down, e.g., recursive descent, parser. A resolver, which (similar to the timing analysis tool 104, synthesizer 108, and parser 114) may comprise any combination of hardware, software, and firmware, generates a solution set 120 of paths, based upon the data structure 110 and tree structure 116, that satisfies at least one of the segmented expressions of the nodal query 112. Accordingly, the nodal query 112 and corresponding solution set 120 can provide visibility into the behavior of the circuit under design by identifying which node or nodes are responsible for one or more failing paths. It should be understood that the solution set 120 may include a null set or at least one path. The circuit designer can utilize the information gathered from the solution set to redesign and improve the circuit by eliminating failing paths. The improved circuit design may then be retested. In this respect, the system and method for circuit analysis presented herein may effectuate a repetitive step in an iterative circuit design process.

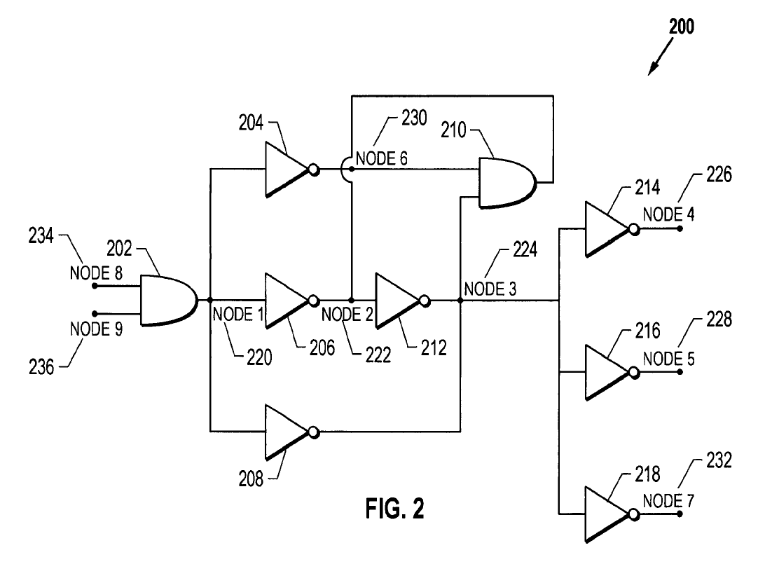

FIG. 2 depicts one embodiment of a circuit 200 that may be analyzed by the system 100 of FIG. 1 for purposes of illustration. An AND circuit 202 drives a signal to three inverter circuits 204-208 which are disposed in parallel with respect to one another. The inverter circuit 204 drives a first input to an AND circuit 210 which, along with the inverter circuit 206, supplies signals to an inverter circuit 212 that provides a second input to the AND circuit 210. The inverter circuits 208 and 212 drive signals to inverter circuits 214-218. Nodes 220-238, which are designated as node 1-node 9, are defined at each of the electrical junctions between the logic gates within the circuit 200. As previously discussed, the timing analysis tool utilizes the netlist that describes circuit 200 to generate the path information, which, in one embodiment, may be represented in a tabular format as shown in the following table:

TABLE 4
Path Information

| PATH | NODE(S) |
|---|---|
| Path 1 | node 1, node 2, node 3, node 4 |
| Path 2 | node 1, node 3, node 7 |
| Path 3 | node 9, node 1, node 3, node 2 |
| Path 4 | node 1, node 6, node 2, node 3 |
| Path 5 | node 8, node 1, node 6, node 2, |
| | node 3, node 5 |

The path information for circuit 200 indicates that Path 1 comprises the electrical route that couples node 1, node 2, node 3, and node 4 together. Hence, Path 1 describes the electrical route from the input of inverter circuit 206 to inverter circuit 212 to the output of inverter circuit 214. By way of another example, the path information for circuit 200 indicates that Path 3 comprises the electrical route that couples node 9, node 1, node 3, and node 2 together. Based on circuit 200, it follows that Path 3 describes the electrical route from one of the inputs of AND circuit 202 to inverter circuit 208 to the output of inverter circuit 212 and finally to one of the inputs of AND circuit 210 (which also happens to be the input of inverter circuit 212).

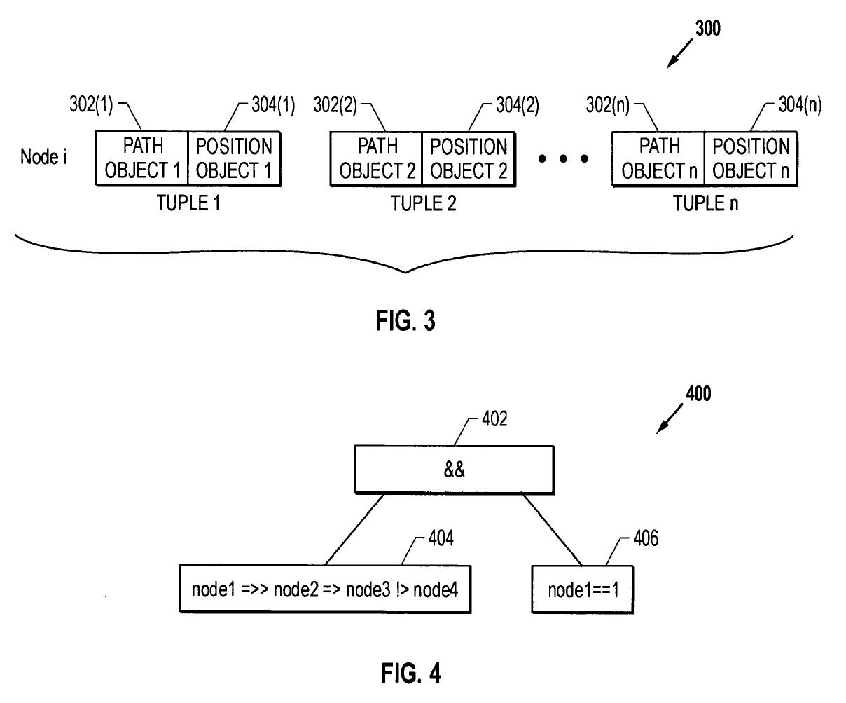

FIG. 3 depicts one embodiment of a data element 300 that is generated during the analysis of the circuit of FIG. 2. In particular, the data element 300 forms a portion of the data structure 110 (shown in FIG. 1) and is generated by the synthesizer upon receipt of the path information. Each node, which is generally represented as Node i, includes a series of n ordered tuples each having a path indicium object, a position indicium object, and an edge indicium object (rising or falling). As illustrated, only path and position indicia are exemplified for the sake of simplicity. Accordingly, path object 302(1) and position object 304(1) are shown as tuple 1, where the path object 302(1) indicates that Node i is associated with a particular path identified by it and the position object 304(1) indicates the location of Node i within the path. By way of example, with respect to node 1, the path object 302(1) and position object 304(1) may be expressed as the ordered pair (2,1) to indicate that node 1 is located in the first nodal position of path 2. Similarly, path objects 302(k) and position objects 304(k), k=2, 3, . . . , n, are provided for tuples 2 through n, respectively.

A tabular representation of the data structure corresponding to the path information of the circuit 200 (shown in FIG. 2) is presented in the following table:

TABLE 5
Data Structure

| NODE | ORDERED LIST OF TUPLES |
|---|---|
| node 1 | (1, 1) (2, 1) (3, 2) (4, 1) (5, 2) |
| node 2 | (1, 2) (3, 4) (4, 3) (5, 4) |
| node 3 | (1, 3) (2, 2) (3, 3) (4, 4) (5, 5) |
| node 4 | (1, 4) |
| node 5 | (5, 6) |
| node 6 | (4, 2) (5, 3) |
| node 7 | (2, 3) |
| node 8 | (5, 1) |
| node 9 | (3, 1) |

By way of additional explanation, with reference to node 1, since node 1 is the first node in path 1, the data structure contains a tuple (1,1). Further, to represent that node 1 is the second node in Path 5, the data structure includes a tuple (5,2). Accordingly, as depicted in Table 5, the data structure provides a searchable format that defines each node in terms of positional path data. Although the illustrative data structure embodiment contains an ordered list of tuples for each node wherein each tuple includes a path object and a position object, it should be appreciated that an alternate data structure embodiment may contain additional objects such as an edge object (rising/falling) as alluded to hereinabove.

FIG. 4 depicts one embodiment of a tree structure 400 that is generated based on an illustrative nodal query during the analysis of the circuit 200 of FIG. 2. As previously discussed, the parser 114 receives a nodal query and parses it to generate the tree structure. With respect to the illustrated tree structure 400, the following expression represents the corresponding nodal query:
node 1=>>node 2=>node 3!>node 4&& node 1==1
The parser parses this nodal query such that the operation of set-level logical operators gives rise to a root of the tree structure 400 wherein the segmented expressions are the leaves of the tree. More particularly, the nodal query is parsed such that the set operator [&&] forms root 402, the segmented expression [node 1=>>node 2=>>node 3!>node 4] forms leaf 404, and segmented expression [node 1==1] forms leaf 406.

The path-node resolver 118 accesses the tree structure 400 and the data structure of Table 5 to hierarchically determine a solution set that satisfies the illustrative nodal query. Thus, the solution set for leaf 404 is {Path 4, Path 5} and the solution set for leaf 406 is {Path 1, Path 2, Path 4}. Hence, the solution for the entire nodal query expression is {Path 4}. More specifically, with respect to leaf 404 and the information contained in Table 5, Path 1 may be eliminated from the solution set since node 3 is followed by node 4 in Path 1. Path 2 may be discarded from the solution set since Path 2 does not contain node 2. Path 3 does not contain node 2 and node 3 in the order specified by the segmented expression of leaf 404. Therefore, Path 3 may be eliminated from the solution set. Path 4 includes nodes 1-3 in the correct order and does not contain node 4. It follows that Path 4 satisfies the segmented expression of leaf 404 and is a member of the solution set. For similar reasons, Path 5 is also a member of the solution set With respect to leaf 406, Paths 1, 2 and 4 satisfy the statement node 1==1 and, accordingly, form the solution set for leaf 406.

By way of example, in one implementation, the parser processes the various nodal operations by gathering the path objects and position objects in each path for each nodal expression. To accomplish this a brute force searching methodology may be utilized or, alternatively, the path information may be pre-processed. After pre-processing, a string of sets of path/stage pairs with an operation (e.g., =>, =>>, !>, or !>>) connecting two consecutive sets in the string are obtained. The algorithm then repeatedly takes the first two sets and the connecting operation and provides replacement sets of path/stage pairs that satisfy the indicated operations. After several iterations of this methodology, a single set of path/stage pairs is obtained. In one implementation, this methodology may be an intersection algorithm that finds the required subset by sorting first by path number information and secondarily by stage number information. It should be appreciated that since the later operators such as [&&] and [||] need only paths, the stage number may be removed from the final result and, similarly, duplicate path numbers may be removed. Further, because the set is ordered by path number, duplicate entries are consecutive and can be deleted in O(n) (linear) time. The following pseudocode represents an exemplary intersection algorithm, with respect to the => operator, that may be utilized with this methodology:

```
set p1 to point to the first element of the first set
set p2 to point to the first element of the second set
make output_set an empty set
if (the operation is ‘=>’){
    //The paths in p1 and p2 have to match, and the stage
    in p2 has to be
    //one more than the stage in p1
    while (p1 is not past the end of the first set AND
        p2 is not past the end of the second set){
    if (p1->path_number<p2->path_number)
        advance p1 to the next element
    else if (p1->path_number>p2>path_number)
        advance p2 to the next element
    else if (p1->stage_number+1<p2->stage_number)
        //The paths match, but the stage number in p1 is
        too small
        advance p1 to the next element
    else if (p1_>stage_number+1>p2->stage_number)
        //The paths match, but the stage number in p1 is
        too big
        advance p2 to the next element
    else
        add p2's element to the end of output_set
        advance p1 to the next element
        advance p2 to the next element
    }
}
```

It should be appreciated that intersection algorithm for the => operator and the intersection algorithms for the other operators may be coded and implemented in a variety of programming languages wherein appropriate nested loops and branching may be utilized in order to correspond to the levels of precedence accorded to the aforementioned logical operators. In one embodiment, the C++ is the programming language. The expanded logic operator syntax and structure of the present system and method therefore provide circuit designers the ability to intuitively craft powerful search expressions that query multiple paths to determine the relationship between particular nodes and failing paths, thereby enabling efficient and accurate identification of critical path delays and path delay validation.

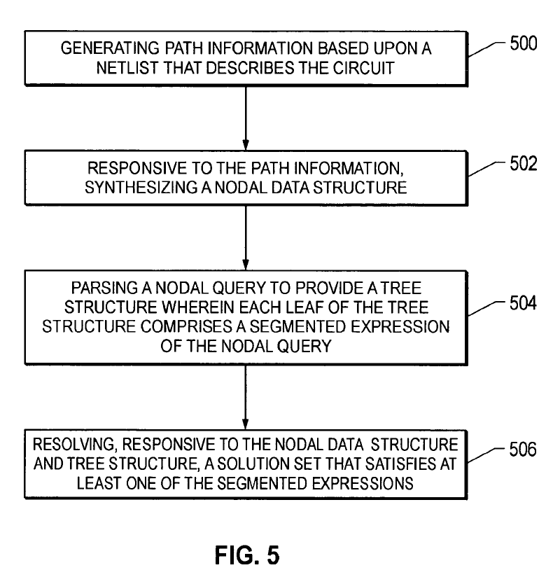

FIG. 5 depicts one embodiment of a method for analyzing a circuit. At block 500, path information is generated based upon a netlist that describes the circuit. At block 502, responsive to the path information, a nodal data structure is synthesized. At block 504, a nodal query is parsed to provide a tree structure, wherein each leaf of the tree structure comprises a segmented expression of the nodal query. At block 506, responsive to the nodal data structure and tree structure, a solution set is resolved that satisfies at least one of the segmented expressions.

Although the invention has been particularly described with reference to certain illustrations, it is to be understood that the forms of the invention shown and described are to be treated as exemplary embodiments only. Various changes, substitutions and modifications can be realized without departing from the spirit and scope of the invention as defined by the appended claims.

What is claimed is:

1. A system for analyzing a circuit, comprising:
a tool for generating path information based upon a netlist that describes said circuit;
a synthesizer for generating a nodal data structure responsive to said path information;
a parser operable to parse a nodal query to provide a tree structure, wherein each leaf of said tree structure comprises a segmented expression of said nodal query; and
a resolver, responsive to said nodal data structure and tree structure, for generating a solution set that satisfies at least one of said segmented expressions.

2. The system as recited in claim 1, wherein said path information comprises an electrical route coupling a plurality of nodes of said circuit.

3. The system as recited in claim 1, wherein said nodal data structure comprises a plurality of tuples associated with a circuit node, each tuple having multiple path object and a position object.

4. The system as recited in claim 1, wherein said nodal query comprises an expression having one or more nodes joined by one or more logical operators.

5. The system as recited in claim 4, wherein said logical operators are selected from the group consisting of AND, OR, and NOT.

6. The system as recited in claim 4, wherein said logical operators comprise operators that express a position of a node with respect to a position of another node.

7. The system as recited in claim 1, wherein said solution set comprises a null set.

8. The system as recited in claim 1, wherein said solution set comprises at least one path.

9. A method for analyzing a circuit, comprising:
generating path information based upon a netlist that describes said circuit;
responsive to said path information, synthesizing a nodal data structure;
parsing a nodal query to provide a tree structure, wherein each leaf of said tree structure comprises a segmented expression of said nodal query; and
resolving, responsive to said nodal data structure and tree structure, a solution set that satisfies at least one of said segmented expressions.

10. The method as recited in claim 9, wherein generating said path information comprises generating a list of electrical routes that each couple a plurality of nodes of said circuit.

11. The method as recited in claim 9, wherein synthesizing said nodal data structure comprises generating a plurality of tuples associated with a circuit node, each tuple having a path object and a position object associated with said circuit node.

12. The method as recited in claim 9, wherein parsing said nodal query is performed by a recursive descent parser.

13. The method as recited in claim 9, wherein parsing said nodal query is performed by a shift-reduce parser.

14. The method as recited in claim 9, wherein parsing said nodal query comprises utilizing a logical syntax that includes operators selected from the group consisting of AND, OR, and NOT.

15. The method as recited in claim 9, wherein parsing said nodal query comprises utilizing a logical syntax that includes operators that express a position of a node with respect to a position of another node.

16. The method as recited in claim 9, wherein said solution set comprises a null set.

17. The method as recited in claim 9, wherein said solution set comprises at least one path.

18. A system for analyzing a circuit, comprising:
means for generating path information based upon a netlist that describes said circuit;
means, responsive to said path information, for synthesizing a nodal data structure;
means for parsing a nodal query to provide a tree structure, wherein each leaf of said tree structure comprises a segmented expression of said nodal query; and
means, responsive to said nodal data structure and tree structure, for resolving a solution set that satisfies at least one of said segmented expressions.

19. The system as recited in claim 18, wherein said path information comprises a list of electrical routes that each couple a plurality of nodes of said circuit.

20. The system as recited in claim 18, wherein said nodal data structure comprises a plurality of tuples associated with a circuit node, each tuple having a path object and a position object.

21. The system as recited in claim 18, wherein said nodal query comprises an expression having one or more nodes joined by one or more logical operators.

22. The system as recited in claim 21, wherein said logical operators are selected from the group consisting of AND, OR, and NOT.

23. The system as recited in claim 21, wherein said logical operators comprise operators that express a position of a node with respect to a position of another node.

24. The system as recited in claim 18, wherein said solution set comprises a null set.

25. The system as recited in claim 18, wherein said solution set comprises at least one path.
